(19) United States
(12) Patent Application Publication
(10) Pub. No.: US 2019/0058191 A1
(43) Pub. Date: Feb. 21, 2019

(54) Lithium Metal Composite Oxide Having Layered Structure

(71) Applicant: Mitsui Mining & Smelting Co., Ltd., Tokyo (JP)

(72) Inventors: Tetsuya Mitsumoto, Takehara-shi (JP); Toshikazu Matsuyama, Takehara-shi (JP); Daisuke Washida, Takehara-shi (JP); Daisuke Inoue, Takehara-shi (JP); Hideaki Matsushima, Takehara-shi (JP); Shinya Kagei, Takehara-shi (JP)

(21) Appl. No.: 16/079,354

(22) PCT Filed: Feb. 27, 2017
(86) PCT No.: PCT/JP2017/007293

§ 371 Date: Aug. 23, 2018

(30) Foreign Application Priority Data
Feb. 26, 2016 (JP) 2016-035835

(51) Int. Cl. H01M 4/525; C01G 53/00; H01M 4/505; H01M 10/0525

(52) U.S. Cl. CPC H01M 4/525; C01G 53/50; H01M 4/505; H01M 2004/028; C01P 2006/80; C01P 2006/40; C01P 2002/22; H01M 10/0525

(57) ABSTRACT

Proposed is a novel lithium metal composite oxide having a layered structure, which is capable of improving the cycle characteristics in the case of using as a positive electrode active material for a battery. Proposed is a lithium metal composite oxide having a layered structure, which is represented by Li₁₊ₓNi_{1-x-α-β-γ}Mn_{α}Co_{β}M_{γ}O₂ (wherein 0≤x≤0.1, 0.01≤α≤0.35, 0.01≤β≤0.35, 0≤γ≤0.05, and M comprises at least one or more elements selected from the group consisting of Al, Mg, Ti, Fe, Zr, W, Y, and Nb), wherein the amount of residual Li₂CO₃ present in secondary particles is 0.03 to 0.3 wt %.

### TECHNICAL FIELD

The present invention relates to a lithium metal composite oxide having a layered structure which can be used as a positive electrode active material of a lithium battery, and particularly, to a lithium metal composite oxide which is capable of exhibiting excellent performance as a positive electrode active material of a battery that is mounted on an electric vehicle (EV) or a hybrid electric vehicle (HEV).

### BACKGROUND ART

Lithium batteries, particularly, lithium secondary batteries have characteristics of high energy density, long life, and the like. Therefore, lithium secondary batteries are used as power supplies for electric appliances such as video cameras; and portable electronic devices such as laptop computers and mobile telephones. Recently, the lithium secondary batteries are also applied to large-sized batteries that are mounted on electric vehicles (EVs), hybrid electric vehicles (HEVs), and the like.

The lithium secondary battery is a secondary battery having a structure in which, at the time of charging, lithium begins to dissolve as ions from the positive electrode and moves to the negative electrode to be stored therein, and at the time of discharging, lithium ions return from the negative electrode to the positive electrode, and it is known that the higher energy density of the lithium secondary battery is attributable to the electric potential of the positive electrode material.

As a positive electrode active material of the lithium secondary battery, in addition to lithium-manganese oxide (LiMn₂O₄) having a spinel structure, lithium metal composite oxides having a layered structure, such as LiCoO₂, LiNiO₂, and LiMnO₂, are known. For example, LiCoO₂ has a layered structure in which a lithium atom layer and a cobalt atom layer are alternately overlapped with an oxygen atom layer interposed therebetween, and has large charge and discharge capacity and excellent diffusibility in intercalation and deintercalation of lithium ions. Accordingly, the majority of lithium secondary batteries commercially available at present are lithium metal composite oxides having a layer structure, such as LiCoO₂.

The lithium metal composite oxides having a layered structure, such as LiCoO₂ and LiNiO₂, are represented by a general formula of LiMeO₂ (Me: transition metal). A crystal structure of the lithium transition metal oxides having the layered structure belongs to a space group R-3m (“-” is commonly attached to an upper portion of “3” and represents rotary inversion. The same shall apply hereinafter), and a Li ion, a Me ion, and an oxide ion occupy a 3a site, a 3b site, and a 6c site, respectively. Then, these lithium metal composite oxides are known to have a layer structure in which a layer (Li layer) composed of Li ions and a layer (Me layer) composed of Me ions are alternately overlapped with an O layer composed of oxide ions interposed therebetween.

In the related art, with regard to a method of producing the lithium metal composite oxide (LiMₓO₂) having a layered structure, for example, Patent Document 1 discloses a method of producing an active material represented by a formula: LiNiₓMn₁₋ₓO₂ (wherein 0.7≤x≤0.95) which is obtained by adding an alkali solution to a mixed aqueous solution of manganese and nickel to coprecipitate manganese and nickel; adding lithium hydroxide to the coprecipitate; and calcining the resultant mixture.

Patent Document 2 discloses a method of producing a layered lithium-nickel-manganese composite oxide powder to provide a layered lithium-nickel-manganese composite oxide powder having a high bulk density. The method includes drying slurry, which contains at least a lithium source compound, a nickel source compound, and a manganese source compound that are pulverized and mixed in a range of 0.7 to 9.0 in terms of a molar ratio [Ni/Mn] between a nickel atom [Ni] and a manganese atom [Mn], by spray drying, calcining the resultant compound obtained by drying the slurry to form a layered lithium-nickel-manganese composite oxide powder, and pulverizing the composite oxide powder.

Patent Document 3 proposes a lithium metal composite oxide having a layer structure, which is obtained by, for example, pulverizing the raw material by a wet-type pulverizer or the like so as to be the average powder particle diameter (D50) of 2 μm or less, granulating and drying the resultant pulverized mixture using a thermal spraying dryer or the like, and calcining the resultant dried mixture, wherein the ratio of the crystallite diameter to the D50 determined by a laser diffraction scattering-type particle size distribution measuring method is 0.05 to 0.20.

Patent Document 4 discloses a method of producing a lithium metal composite oxide having a layer structure, wherein, in the method of producing a lithium metal composite oxide having a layer structure by mixing raw materials containing a lithium salt compound, a manganese salt compound, a nickel salt compound, and a cobalt salt compound, and then pulverizing, calcining and crushing, the crushing is performed after the calcination using a high-speed rotary pulverizer having the number of revolutions of 4,000 rpm or more.

### CITATION LIST

### Patent Document

Patent Document 1: Japanese Patent Laid-Open No. 8-171910
Patent Document 2: Japanese Patent Laid-Open No. 2003-34536
Patent Document 3: Japanese Patent No. 4213768 (WO2008/091028)
Patent Document 4: Japanese Patent Laid-Open No. 2013-232400

### SUMMARY OF THE INVENTION

### Problem to be Solved by the Invention

The lithium metal composite oxide having a layered structure has a problem in that, because of the layered structure, even if the calcination temperature is high, unreacted Li is remained in the lithium metal composite oxide, and as a result, the cycle characteristics cannot be effectively enhanced. Especially for a positive electrode active material of a battery mounted on an electric vehicle, cycle characteristics, which cannot be expected for other applications, are required, and thus enhancing the cycle characteristics has been an extremely critical problem to solve.

Thus, the present invention is to provide a novel lithium metal composite oxide having a layered structure, which is capable of improving the cycle characteristics in the case of using as a positive electrode active material for a battery.

### Means for Solving Problem

The present invention proposes a lithium metal composite oxide having a layered structure, which is represented by a general formula (1): Li₁₊ₓNi_{1-x-α-β-γ}Mn_{α}Co_{β}M_{γ}O₂ (wherein 0≤x≤0.1, 0.01≤α≤0.35, 0.01≤β≤0.35, 0≤γ≤0.05, and M comprises at least one or more elements selected from the group consisting of Al, Mg, Ti, Fe, Zr, W, Y, and Nb), wherein an amount of residual alkali present in secondary particles (according to the following measurement method; referred to as “residual alkali amount in secondary particles”) is 0.05 to 0.4 wt %.

(Method of Measuring Residual Alkali Amount in Secondary Particles)

A lithium metal composite oxide is pulverized such that an average particle diameter (D50) thereof becomes 5 to 50%; 10.0 g of the lithium metal composite oxide after the pulverization is dispersed in 50 mL of ion-exchanged water, immersed therein for 15 min, and thereafter filtered; and the filtrate is titrated with hydrochloric acid (Winkler method). At this time, by using phenolphthalein and bromophenol blue as indicators, a total amount of an amount of LiOH and an amount of Li₂CO₃ is calculated based on the discoloration of the filtrate and the amount of titration at this time, and a mass ratio (wt %) of the total amount to the amount of the lithium metal composite oxide is set as a residual alkali amount in secondary particles.

### Effect of the Invention

The lithium metal composite oxide proposed by the present invention has characteristics that not only the amount of residual alkali is simply low, but also the amount of residual alkali present in secondary particles is low. Therefore, when the lithium metal composite oxide proposed by the present invention is used as a positive electrode active material for a battery, the cycle characteristics can be particularly enhanced. Therefore, the lithium metal composite oxide proposed by the present invention is especially excellent as a positive electrode active material for a vehicular battery, especially a battery mounted on an electric vehicle (EV).

### BRIEF DESCRIPTION OF DRAWINGS

FIG. 1 is an outline diagram of a cell for electrochemical evaluation, used for battery characteristics evaluations in Examples.

### MODE(S) FOR CARRYING OUT THE INVENTION

Hereinafter, embodiments of the present invention will be described. The present invention, however, is not limited to the following embodiments.

<Present Lithium Metal Composite Oxide>

The lithium metal composite oxide according to an exemplary embodiment of the present invention (referred to as “present lithium metal composite oxide”) is a lithium metal composite oxide having a layered structure, which is represented by a general formula (1): Li₁₊ₓNi_{1-x-α-β-γ}Mn_{α}Co_{β}M_{γ}O₂ (wherein 0≤x≤0.1, 0.01≤α≤0.35, 0.01≤β≤0.35, 0≤γ≤0.05, and M comprises at least one or more elements selected from the group consisting of Al, Mg, Ti, Fe, Zr, W, Y, and Nb).

Here, the “lithium metal composite oxide having a layer structure” means a lithium metal composite oxide having a layer structure in which a lithium atom layer and a transition metal atom layer are alternately overlapped with an oxygen atom layer interposed therebetween.

The parameter “x” in the general formula (1) preferably satisfies 0≤x≤0.1. Among others, it is more preferably 0.01 or more or 0.07 or less, even more preferably 0.03 or more or 0.05 or less.

The parameter “α” in the general formula (1) preferably satisfies 0.01≤α≤0.35. Among others, it is more preferably 0.05 or more or 0.33 or less, even more preferably 0.1 or more or 0.3 or less.

The parameter “β” in the general formula (1) preferably satisfies 0.01≤β≤0.35. Among others, it is more preferably 0.05 or more or 0.33 or less, even more preferably 0.1 or more or 0.2 or less.

The parameter “γ” in the general formula (1) preferably satisfies 0≤γ≤0.05. Among others, it is more preferably 0.01 or more or 0.08 or less, even more preferably 0.05 or less.

The parameter “M” in the general formula (1) may contain at least one or more elements selected from the group consisting of Al, Mg, Ti, Fe, Zr, W, Y, and Nb. Two or more of these may be contained in combination.

Here, in the general formula (1), the atomic ratio of the amount of oxygen is stated as “2” for convenience, but is allowed to be more or less unfixed.

The present lithium metal composite oxide may contain 1.0% by weight or less of SO₄, and 0.5% by weight or less of other elements as impurities. This is because, it may be considered that the characteristics of the present lithium metal composite oxide are hardly affected by impurities in such an amount.

<Surface Layer>

The present lithium metal composite oxide may comprise a surface portion where one or a combination of two or more (these are referred to as “surface element C”) of the group consisting of Al, Ti, and Zr is present on the surface of the particle. However, the present lithium metal composite oxide may not necessarily comprise such a surface portion.

The surface portion mentioned here is characterized by having portions where the concentration of the surface element C is higher than that in the particle inner portion are present on the particle surface.

A thickness of the surface portion is, from the viewpoint of suppressing the reaction with an electrolyte solution and improving the charge-discharge cycle ability, and maintaining or improving the output characteristics and the rate characteristics, preferably 0.1 to 100 nm. Among others, it is more preferably 5 nm or more or 80 nm or less, even more preferably 60 nm or less.

When the surface portion is present on the surface of the present lithium metal composite oxide particle, and in the case where the present lithium metal composite oxide particle is used as a positive electrode active material of a lithium secondary battery, the reaction with an electrolyte solution is suppressed and the charge-discharge cycle ability is improved, and the rate characteristics and the output characteristics can be made equal to or more than those of conventionally proposed surface-treated positive electrode active materials.

Whether or not the surface portion where the surface element C is present is present on the surface of the present lithium metal composite oxide particle can be judged by whether or not the concentration of the surface element C in the particle surface is higher than that in the particle inner portion. Specifically, it can be judged, for example, by observing the particle by a scanning transmission electron microscope (STEM) and checking whether or not any peak of the surface element C is observed on the surface portion of the particle.

Above all, a ratio (C/M) of an intensity (in the case where the surface element C contains two or more elements, the total intensity) of the surface element C to an intensity (in the case where the constituent element M contains two or more elements, the total intensity) of the constituent element M, which is measured by XPS, is preferably more than 0 and less than 0.8.

When the surface element C is present such that the ratio (C/M) becomes less than 0.8, the reaction with an electrolyte solution can be suppressed and the charge-discharge cycle ability can be improved. In addition, the output characteristics and the rate characteristics can be made equal to or more than those of conventionally proposed surface-treated positive electrode active materials.

From such a viewpoint, the ratio (C/M) is preferably more than 0 and less than 0.8. Among others, it is more preferably 0.6 or less, even more preferably 0.4 or less, still more preferably 0.3 or less.

As such, in order to adjust the ratio (C/M) to be more than 0 and less than 0.8, for example, when the present lithium metal composite oxide particle is subjected to a surface treatment, the amount of the surface element C in a surface treating agent may be adjusted, and the subsequent heat treatment temperature may be adjusted. However, it is not limited to these methods.

<Residual Alkali Amount in Secondary Particles>

The present lithium metal composite oxide has characteristics that an amount of residual alkali present in secondary particles (referred to as “residual alkali amount in secondary particles”), which is measured according to the following measurement method, is 0.05 to 0.4 wt %.

Among others, from the viewpoint of further reducing the reaction with an electrolyte solution, the residual alkali amount in secondary particles in the present lithium metal composite oxide is more preferably less than 0.4 wt %, even more preferably 0.3 wt % or less, still more preferably 0.2 wt % or less.

(Method of Measuring Residual Alkali Amount in Secondary Particles)

A lithium metal composite oxide is pulverized such that an average particle diameter (D50) thereof becomes 5 to 50%; 10.0 g of the lithium metal composite oxide after the pulverization is dispersed in 50 mL of ion-exchanged water, immersed therein for 15 min, and thereafter filtered; and the filtrate is titrated with hydrochloric acid (Winkler method). At this time, by using phenolphthalein and bromophenol blue as indicators, a total amount of an amount of LiOH and an amount of Li₂CO₃ is calculated based on the discoloration of the filtrate and the amount of titration at this time, and a mass ratio (wt %) of the total amount to the amount of the lithium metal composite oxide is set as a residual alkali amount in secondary particles.

<Residual Li₂CO₃ Amount in Secondary Particles>

In the present lithium metal composite oxide, an amount of residual Li₂CO₃ present in secondary particles (referred to as “residual Li₂CO₃ amount in secondary particles”), which is measured according to the following measurement method, is preferably 0.03 to 0.3 wt %.

Among others, from the viewpoint of further reducing the reaction with an electrolyte solution, the residual Li₂CO₃ amount in secondary particles in the present lithium metal composite oxide is more preferably less than 0.3 wt %, even more preferably 0.2 wt % or less, still more preferably 0.1 wt % or less.

(Method of Measuring Residual Li₂CO₃ Amount in Secondary Particles)

A lithium metal composite oxide is pulverized such that the average particle diameter (D50) thereof becomes 5 to 50%; 10.0 g of the lithium metal composite oxide after the pulverization is dispersed in 50 mL of ion-exchanged water, immersed therein for 15 min, and thereafter filtered; and the filtrate is titrated with hydrochloric acid (Winkler method). At this time, by using phenolphthalein and bromophenol blue as indicators, the amount of Li₂CO₃ is calculated based on the discoloration of the filtrate and the amount of titration at this time, and a mass ratio (wt %) of the amount of Li₂CO₃ to the lithium metal composite oxide is set as a residual Li₂CO₃ amount in secondary particles.

<Residual Alkali Amount Per Specific Surface Area>

In the present lithium metal composite oxide, a residual alkali amount before pulverization (referred to as “residual alkali amount per specific surface area), which is measured according to the following measurement method, is less than 0.6 (wt %/(m²/g)), and when the present lithium metal composite oxide is pulverized such that the average particle diameter (D50) thereof becomes 5 to 50%, a ratio (B/A) of a change rate (B) of the residual alkali amounts before and after pulverization (according to the following measurement method) to a change rate (A) of the specific surface areas before and after pulverization, is preferably 0.2 or less.

When the present lithium metal composite oxide is pulverized such that the D50 becomes 5 to 50%, a ratio (B/A) of a change rate (B) of the residual alkali amounts before and after pulverization to a change rate (A) of the specific surface areas before and after pulverization is small, which means that, although the D50 is changed, an increase in the residual alkali amount is suppressed, that is, it is indicated that the amount of the residual alkali present at the grain boundaries in secondary particles is small. As to the residual alkali present at the grain boundaries in secondary particles, the grain boundary surface becomes a newly formed surface by expansion and contraction of the particle in charging and discharging, and the residual alkali present at the grain boundaries is reacted with an electrolyte solution. Thus, it is necessary to suppress such a reaction.

Meanwhile, from the results of the tests carried out by the present inventors, it has been known that nearly the same results of the change rate (A) of the specific surface areas before and after pulverization and the change rate (B) of the residual alkali amounts before and after pulverization can be obtained, even when the present lithium metal composite oxide is pulverized such that the D50 becomes 5% or 50%.

Therefore, from the viewpoint of minimizing the reaction with an electrolyte solution, the residual alkali amount before pulverization is preferably less than 0.6 (wt %/(m²/g)), more preferably less than 0.5 (wt %/(m²/g)), even more preferably less than 0.3 (wt %/(m²/g)).

Further, from the viewpoint of suppressing the reaction between the residual alkali present at the grain boundaries in secondary particles and an electrolyte solution, the ratio (B/A) of the change rate (B) of the residual alkali amounts before and after pulverization, is preferably 0.2 or less. Among others, it is more preferably 0.01 or more and 0.2 or less, even more preferably 0.05 or more or 0.18 or less.

(Method of Measuring Residual Alkali Amount Before or after Pulverization)

10.0 g of the lithium metal composite oxide before the pulverization or after the pulverization is dispersed in 50 mL of ion-exchanged water, immersed therein for 15 min, and thereafter filtered; and the filtrate is titrated with hydrochloric acid (Winkler method). At this time, a method in which, by using phenolphthalein and bromophenol blue as indicators, the total amount of the amount of LiOH and the amount of Li₂CO₃ is calculated based on the discoloration of the filtrate and the amount of titration at this time, and the mass ratio (wt %) of the total amount to the amount of the lithium metal composite oxide is set as a residual alkali amount before pulverization or after pulverization, can be cited.

In order to adjust the residual alkali amount in secondary particles of the present lithium metal composite oxide, the residual Li₂CO₃ amount in secondary particles thereof, and the residual alkali amount per specific surface area thereof to the above ranges, it is preferable that the calcination conditions are adjusted, a surface treatment is performed, or washing is performed. However, it is not limited to such a method.

<Average Particle Diameter (D50)>

An average particle diameter (D50) of the present lithium metal composite oxide, that is, the D50 obtained according to a laser diffraction scattering-type particle size distribution measuring method is preferably 0.5 to 30 μm. Among others, it is more preferably 1 μm or more or 20 μm or less, even more preferably 2 μm or more or 10 μm or less.

When the D50 of the present lithium metal composite oxide is 2 to 10 μm, it is convenient from the viewpoint of electrode production.

In order to adjust the D50 of the present lithium metal composite oxide to the above ranges, it is preferable to perform an adjustment of D50 of starting raw materials, an adjustment of calcination temperature or calcination time, or an adjustment of D50 by crushing after calcination. However, it is not limited to these adjustment methods.

Here, a particle made by aggregation of a plurality of the primary particles with parts of their outer peripheries (grain boundaries) being shared, with the particle being isolated from other particles, is referred to as a “secondary particle” or an “aggregated particle” in the present invention.

Incidentally, the laser diffraction scattering-type particle size distribution measuring method is a measuring method of calculating a particle diameter by taking an aggregated powder particle as one particle (aggregated particle); and the average particle diameter (D50) means a 50% volume-cumulative particle diameter, that is, a diameter at a cumulation of 50% from the finer side in a cumulative percentage representation of particle diameter measurement values in terms of volume in a chart of a particle size distribution in terms of volume.

<Primary Particle Diameter>

A primary particle diameter of the present lithium metal composite oxide, that is, the primary particle diameter determined from a SEM image is preferably 0.3 to 2.0 μm.

When the primary particle diameter of the present lithium metal composite oxide falls within the above range, the Li diffusion resistance in the particles can be suppressed, and the improvement of the output characteristics can be attempted.

From such a viewpoint, the primary particle diameter of the present lithium metal composite oxide is preferably 0.3 to 2.0 μm. Among others, it is more preferably 0.4 μm or more or 1.8 μm or less, even more preferably 0.5 μm or more or 1.6 μm or less.

Examples of the production method of the present lithium metal composite oxide in order to adjust the primary particle diameter of the present lithium metal composite oxide to the above ranges may include adjusting the calcination temperature, adding a material, which enhances the reactivity in calcination, and calcining. However, it is not limited to this method.

<Specific Surface Area>

A specific surface area (SSA) of the present lithium metal composite oxide, that is, the specific surface area (SSA) before pulverization is preferably 0.2 to 2.0 m²/g.

The specific surface area (SSA) of the present lithium metal composite oxide is preferably 0.2 to 2.0 m²/g since the reaction field where Li intercalates and deintercalates can be sufficiently secured, and thus the output characteristics and the rate characteristics can be maintained.

From such a viewpoint, the specific surface area (SSA) of the present lithium metal composite oxide is preferably 0.2 to 2.0 m²/g. Among others, it is more preferably 1.8 m²/g or less, even more preferably 1.5 m²/g or less.

In order to adjust the specific surface area of the present lithium metal composite oxide powder to the above ranges, it is preferable that the calcination conditions and the crushing conditions are adjusted. However, it is not limited to these adjustment methods.

<Production Method>

The present lithium metal composite oxide can be produced according to the production method that will be described below. However, it is not limited to this production method.

An example of the production method of the present lithium metal composite oxide may be a production method comprising: first, a step (referred to as “first step”) of calcining (the calcination in the first step is also referred to as “temporary calcination”) the lithium metal composite oxide (E) in which the amount of Li is insufficient compared with the lithium metal composite oxide to be produced (referred to as “lithium metal composite oxide (D)”); and a step (referred to as “second step”) of obtaining the lithium metal composite oxide (D) by mixing the obtained lithium metal composite oxide (E) and a lithium compound and then calcining (the calcination in the second step is also referred to as “main calcination”) the resultant mixture.

When the lithium metal composite oxide (D) to be produced is produced without preparing the lithium metal composite oxide (E), because of the layered structure, unreacted Li is remained in the lithium metal composite oxide (D), and thus the performance as a positive electrode active material, for example, the cycle characteristics decrease. In contrast, according to the method, in which, first, the lithium metal composite oxide (E) in which the amount of Li is insufficient compared with the lithium metal composite oxide (D) to be produced is temporary calcined, and subsequently, a lithium compound is added to the lithium metal composite oxide (E) and the resultant mixture is main calcined to obtain the lithium metal composite oxide (D), unreacted Li in the lithium metal composite oxide (D) can be effectively reduced even having a layered structure.

Here, unless particularly stated otherwise, the lithium metal composite oxides (D) and (E) comprise a meaning of a state of aggregation or powder.

<First Step>

In the first step, the lithium metal composite oxide (E), which is represented by a general formula (2): Li₁₊ₓNi_{1-x-α-β-γ}Mn_{α}C_{β}M_{γ}O₂ (wherein −0.7≤x≤−0.05, 0.01≤α≤0.35, 0.01≤β≤0.35, 0≤γ≤0.05, and M comprises at least one or more elements selected from the group consisting of Al, Mg, Ti, Fe, Zr, W, Y, and Nb), may be obtained.

More specifically, the lithium metal composite oxide (E) may be obtained in such a manner that a lithium raw material, a nickel raw material, a manganese raw material, a cobalt raw material, and furthermore, M raw materials containing the M elements in the general formula (2) are weighed so as to be the composition represented by the general formula (2) and mixed; and the resultant mixture is pulverized as necessary, granulated, calcined, subjected to a heat treatment as necessary, crushed as necessary, and then classified as necessary.

A molar ratio of Li in the lithium metal composite oxide (E) is, from the viewpoint of effectively reducing the unreacted Li in the lithium metal composite oxide (D), preferably 45 to 95% with respect to the Li content (molar ratio) in the lithium metal composite oxide (D). Among others, it is more preferably 50% or more or 93% or less, even more preferably 60% or more or 90% or less.

(Raw Material)

Examples of the lithium raw material may include lithium hydroxide (LiOH), lithium carbonate (Li₂CO₃), lithium nitrate (LiNO₃), LiOH.H₂O, lithium oxide (Li₂O), and besides, lithium compounds such as fatty acid lithium and lithium halides. Among others, hydroxide salt, carbonate salt, and nitrate salt of lithium are preferable.

The manganese raw material is not especially limited. For example, manganese compounds such as manganese carbonate, manganese nitrate, manganese chloride, and manganese dioxide can be used, and among these, manganese carbonate and manganese dioxide are preferable. Among others, electrolytic manganese dioxide that is obtained by an electrolytic method is more preferable.

The nickel raw material is not especially limited. For example, nickel compounds such as nickel carbonate, nickel nitrate, nickel chloride, nickel oxyhydroxide, nickel hydroxide, and nickel oxide can be used, and among these, nickel carbonate, nickel hydroxide, and nickel oxide are preferable.

The cobalt raw material is not especially limited. For example, cobalt compounds such as basic cobalt carbonate, cobalt nitrate, cobalt chloride, cobalt oxyhydroxide, cobalt hydroxide, and cobalt oxide can be used, and among these, basic cobalt carbonate, cobalt hydroxide, cobalt oxide, and cobalt oxyhydroxide are preferable.

As the raw materials of the M elements in the general formula (2), that is, the raw materials of Al, Mg, Ti, Fe, Zr, W, Y, and Nb, M element compounds such as oxides, hydroxides, carbonates, and the like of these elements can be used.

Further, a boron compound may be blended as a raw material. Blending a boron compound can promote the calcination.

The boron compound may be a compound containing boron (B element), and for example, it is preferable to use boric acid or a lithium borate. As the lithium borate, various forms thereof, for example, lithium metaborate (LiBO₂), lithium tetraborate (Li₂B₄O₇), lithium pentaborate (LiB₅O₈), and lithium perborate (Li₂B₂O₅) can be used.

(Mixing)

As a mixing method of the raw materials, it is preferable to employ a wet-type mixing method in which liquid media such as water and a dispersant are added to and mixed with the raw materials and made into a slurry. Meanwhile, in the case of employing a spray drying method described later, the obtained slurry is preferably pulverized by a wet-type pulverizer. However, it may be dry-type pulverized.

At this time, from the viewpoint of improving the reactivity in calcining the raw materials, it is preferable that the raw materials are introduced into a liquid medium, and the resultant materials are wet-type pulverized and mixed such that the average particle diameter becomes 0.5 μm or less.

(Granulation)

A granulation method may be of a wet-type or a dry-type as long as the raw materials thus mixed are not separated and are dispersed in granulated particles.

The granulation method may be an extruding granulation method, a tumbling granulation method, a fluidized granulation method, a mixing granulation method, a spray drying granulation method, a pressing granulation method, or a flake granulation method using a roll or the like. However, in the case of performing the wet-type granulation, sufficient drying before the temporary calcination is needed.

The drying may be performed by a well-known drying method such as a spray heat drying method, a hot air drying method, a vacuum drying method, or a freeze drying method, and among these, a spray heat drying method is preferable. The spray heat drying method is preferably performed by using a thermal spraying dryer (spray dryer) (referred to as “spray drying method” in the present description).

A granulated powder obtained by a coprecipitation method may be used. As the coprecipitation method, there can be exemplified a production method of a composite hydroxide containing different elements coexisting therein, in which the hydroxide is precipitated by adjusting conditions such as pH after raw materials are dissolved in a solution.

Among others, in the present production method, it is preferable, on the point that the effect of the present invention can be further enjoyed, that the slurry is wet-type pulverized and mixed such that the average particle diameter becomes 0.5 μm or less as described above, and thereafter the obtained slurry is spray dried using a thermal spraying dryer (spray dryer).

In the case of spray drying using a thermal spraying dryer (spray dryer) as described above, since Li is penetrated into the particle, unreacted Li is readily remained, and the residual alkali amount tends to increase. Thus, the effect by the present production method can be further enjoyed as compared with the case of granulating by, for example, the coprecipitation method.

(Temporary Calcination)

The temporary calcination in the first step may be performed in a calcining furnace in an air atmosphere, an oxygen gas atmosphere, an atmosphere whose oxygen partial pressure is adjusted, a carbon dioxide gas atmosphere, or another atmosphere. The temporary calcination is preferably performed in an atmosphere whose oxygen concentration is 20% or more among these atmospheres.

The calcining temperature of the temporary calcination (meaning a temperature when a thermocouple is brought into contact with a calcination product in a calcining furnace) is preferably in a range of 400 to 800° C. Among others, it is more preferably 500° C. or more or 775° C. or less, even more preferably 600° C. or more or 750° C. or less.

As to the calcination time of the temporary calcination, the calcination is preferably performed so as to maintain the calcining temperature for 0.5 hour to 300 hours.

The kind of the calcining furnace is not especially limited. The calcination can be performed, for example, by using a rotary kiln, a stationary furnace, or another calcining furnace.

(Heat Treatment)

The heat treatment after the temporary calcination is preferably performed in the case where the adjustment of the crystal structure is needed.

The heat treatment can be performed under the condition of an oxidative atmosphere such as an air atmosphere, an oxygen gas atmosphere, or an atmosphere whose oxygen partial pressure is adjusted.

Further, such a heat treatment may be performed by heating after cooling down to room temperature after the calcination, or may be performed, continuously after the calcination, by making the temperature-fall rate down to room temperature to be 1.5° C./min or less.

(Crushing)

The crushing after the temporary calcination or the heat treatment may be performed as required.

As a crushing method at this time, it is preferable that means of not reducing the primary particle diameter is selected. The means specifically includes Orient Mill crushing and crushing using a mortar.

Further, the crushing may be performed by using a low-speed or medium-speed rotary crusher or the like. The crusher includes, for example, a rotary crusher having the number of revolutions of about 1,000 rpm. When the crushing is performed by a low-speed or medium-speed rotary crusher, aggregation of particles and weakly sintered portions can be crushed, and moreover, strains can be prevented from being generated in particles.

However, it is not limited to the above crushing methods.

The classification after the calcination, because of having a technical significance of regulation of the particle size distribution of an aggregated powder and removal of foreign matter, is preferably performed by selecting a sieve having a preferable sieve opening.

(Lithium Metal Composite Oxide (E))

The lithium metal composite oxide (E) may or may not have a layered structure. However, when the lithium metal composite oxide (D) having a layered structure is produced by preparing a structure other than the layered structure, the efficiency cannot be good in terms of energy, and thus the lithium metal composite oxide (E) as an intermediate body preferably has a layered structure.

At this time, by appropriately increasing the amount of Li in the lithium metal composite oxide (E), the layered structure can be made.

The parameter “x” in the general formula (2) preferably satisfies −0.7≤x≤−0.05. Among others, it is more preferably −0.5 or more or −0.05 or less, even more preferably −0.4 or more or −0.1 or less.

The parameter “α” in the general formula (2) preferably satisfies 0.01≤α≤0.35. Among others, it is more preferably 0.05 or more or 0.33 or less, even more preferably 0.1 or more or 0.3 or less.

The parameter “β” in the general formula (2) preferably satisfies 0.01≤β≤0.35. Among others, it is more preferably 0.05 or more or 0.33 or less, even more preferably 0.1 or more or 0.2 or less.

The parameter “γ” in the general formula (2) preferably satisfies 0≤γ≤0.05. Among others, it is more preferably 0.01 or more or 0.04 or less, even more preferably 0.01 or more or 0.03 or less.

The parameter “M” in the general formula (2) may contain at least one or more elements selected from the group consisting of Al, Mg, Ti, Fe, Zr, W, Y, and Nb. Two or more of these may be contained in combination.

Here, in the general formula (2), the atomic ratio of the amount of oxygen is stated as “2” for convenience, but is allowed to be more or less unfixed.

The lithium metal composite oxide (E) obtained in the first step has characteristics that the amount of unreacted Li, in other words, the residual alkali amount is low.

<Second Step>

In the second step, the lithium metal composite oxide (D) may be obtained in such a manner that the lithium metal composite oxide (E) thus obtained in the first step and a lithium compound are mixed; and the resultant mixture is main calcined, subjected to a heat treatment as necessary, crushed as necessary, classified as necessary, subjected to a surface treatment as necessary, subjected to a heat treatment as necessary, crushed as necessary, and then classified as necessary.

(Lithium Compound)

The lithium compound is not especially limited as long as being a compound containing lithium. Particularly, lithium hydroxide or lithium carbonate is preferably used.

As to the lithium compound, from the viewpoint of uniformly mixing the lithium metal composite oxide (E) and the lithium compound, D50 of the lithium compound, which is obtained through measurement by a laser diffraction scattering-type particle size distribution measuring method, is preferably in a range of 1 to 20 μm. Among others, it is more preferably 2 μm or more or 15 μm or less, even more preferably 5 μm or more or 10 μm or less.

Further, in a particle size distribution of the lithium compound according to a volume-based particle size distribution obtained through measurement by a laser diffraction scattering-type particle size distribution measuring method, it is preferable that ((D90−D10)/D50), that is, the relationship among D10, D50, and D90 satisfies ((D90−D10)/D50)=0.1 to 3.

The ((D90−D10)/D50) is an index to indicate sharpness of the particle size distribution. Thus, when the ((D90−D10)/D50) falls within a range of 0.1 to 3, the shape of the particle size distribution is sufficiently sharp, and benefit in which a mixing failure does not occur in mixing, can be enjoyed.

From such a viewpoint, the ((D90−D10)/D50) of the lithium compound is preferably in a range of 0.1 to 3. Among others, it is more preferably 0.3 or more or 3.5 or less, even more preferably 0.4 or more or 2 or less.

When the lithium compound is added to the lithium metal composite oxide (E), it is preferable to adjust the amount of the lithium compound to be added so as to be a composition of the lithium metal composite oxide (D) to be produced.

(Mixing)

As a mixing method of the lithium metal composite oxide (E) and the lithium compound, it is preferable to employ a method of not reducing the primary particle diameter of the lithium metal composite oxide (E).

The mixing method specifically include, for example, use of a ball mill, an SC mill, a mixer, and the like. However, it is not limited to these mixing methods.

(Calcination)

The main calcination in the second step may be performed in a calcining furnace in an air atmosphere, an oxygen gas atmosphere, an atmosphere whose oxygen partial pressure is adjusted, a carbon dioxide gas atmosphere, or another atmosphere. The main calcination is preferably performed in an atmosphere whose oxygen concentration is 20% or more among these atmospheres.

The temperature (highest reached temperature) of the main calcination in the second step is preferably higher than the temperature (highest reached temperature) of the temporary calcination in the first step. Among others, the temperature of the main calcination in the second step is preferably higher by 10 to 200° C. than the temperature of the temporary calcination in the first step, and among others, it is more preferably higher by 20° C. or more or 180° C. or less, even more preferably higher by 30° C. or more or 170° C. or less, still more preferably higher by 40° C. or more or 150° C. or less, further more preferably higher by 100° C. or less.

Specifically, the temperature of the main calcination (:meaning a temperature when a thermocouple is brought into contact with a calcination product in a calcining furnace) is preferably in a range of 700 to 1,000° C. Among others, it is more preferably 800° C. or more or 980° C. or less, even more preferably 850° C. or more or 950° C. or less.

As to the calcination time of the main calcination, the calcination is preferably performed so as to maintain the main calcining temperature for 0.5 hour to 300 hours.

At this time, it is preferable to select calcining conditions where transition metals dissolve in the atomic level as a solid solution and exhibit a single phase.

The kind of the calcining furnace to be used in the main calcination is not especially limited. The calcination can be performed, for example, by using a rotary kiln, a stationary furnace, or another calcining furnace.

(Heat Treatment)

The heat treatment after the main calcination is preferably performed in the case where the adjustment of the crystal structure is needed.

The heat treatment can be performed under the condition of an oxidative atmosphere such as an air atmosphere, an oxygen gas atmosphere, or an atmosphere whose oxygen partial pressure is adjusted.

Further, such a heat treatment may be performed by heating after cooling down to room temperature after the main calcination, or may be performed, continuously after the main calcination, by making the temperature-fall rate down to room temperature to be 1.5° C./min or less.

(Crushing)

The crushing after the main calcination or the heat treatment may be performed as required.

As a crushing method at this time, it is preferable that means of not reducing the primary particle diameter of the main calcined product is selected. The means specifically includes Orient Mill crushing and crushing using a mortar.

Further, the crushing may be performed by using a low-speed or medium-speed rotary crusher or the like. The crusher includes, for example, a rotary crusher having the number of revolutions of about 1,000 rpm. When the crushing is performed by a low-speed or medium-speed rotary crusher, aggregation of particles and weakly sintered portions can be crushed, and moreover, strains can be prevented from being generated in particles.

Further, the crushing may be performed by using a high-speed rotary crusher or the like. By crushing using a high-speed rotary crusher, strongly sintered portions can be crushed.

As an example of the high-speed rotary crusher, a crushing apparatus (for example, a pin mill) in which crushing is performed by pins fixed on a crushing plate rotating at a high speed in a relative direction, can be used. In so doing, the crushing is performed so as not to excessively crush particles, preferably at 4,000 to 10,000 rpm, more preferably 8,000 rpm or less, even more preferably 7,000 rpm or less.

However, it is not limited to the above crushing methods.

The classification after the main calcination, because of having a technical significance of regulation of the particle size distribution of an aggregated powder and removal of foreign matter, is preferably performed by selecting a sieve having a preferable sieve opening.

(Surface Treatment)

The lithium metal composite oxide (D) thus obtained by the main calcination or the heat treatment is preferably subjected to the following surface treatment as required.

As a surface treatment method, the surface treatment is preferably performed by using a surface treating agent containing at least one of aluminum, titanium, and zirconium, with respect to the lithium metal composite oxide (D) thus obtained by the main calcination or the heat treatment.

Examples of the surface treating agent may include a surface treating agent containing an inorganic or organic metal compound containing at least one of aluminum, titanium, and zirconium. In this case, the surface treatment may be performed by bringing the surface treating agent containing an inorganic or organic metal compound containing at least one of aluminum, titanium, and zirconium into contact with the lithium metal composite oxide (D) obtained as described above.

Examples of the surface treating agent containing an organic metal compound may include a surface treating agent such as a titanium coupling agent, an aluminum coupling agent, a zirconium coupling agent, a titanium-aluminum coupling agent, titanium-zirconium coupling agent, an aluminum-zirconium coupling agent, or a titanium-aluminum-zirconium coupling agent. Then, such a surface treating agent is dispersed in an organic solvent to thereby produce a dispersion, and the surface treatment may be performed by bringing the dispersion into contact with the lithium metal composite oxide (D) obtained as described above.

Also, examples of the organic surface treating agent may include compounds having an organic functional group and a hydrolyzable group in their molecule. Among these, compounds having phosphorus (P) on their side chains are preferable. A coupling agent having phosphorus (P) on its side chains, because of being good in affinity for a binder, is especially excellent in bindability with the binder.

However, the surface treating agent containing at least one of aluminum, titanium, and zirconium is not limited to the surface treating agent containing an organic metal compound as described above, and the other surface treating agent containing at least one of aluminum, titanium, and zirconium can be also used.

In the surface treatment, preferably about 0.1 to 20 wt % of the surface treating agent is brought into contact with 100 wt % by of the lithium metal composite oxide (D); and more preferably 0.5 wt % by or more or 10 wt % or less, even more preferably 1 wt % or more or 5 wt % or less, and still more preferably 1 wt % or more or 3 wt % or less of the surface treating agent is brought into contact with the lithium metal composite oxide (D).

Meanwhile, as to the amount of a dispersion in which the coupling agent is dispersed in an organic solvent or water, it is preferable that the amount of the dispersion is adjusted, with respect to 100 wt % of the lithium metal composite oxide (D), in 0.2 to 20 wt %, preferably 1 wt % or more or 15 wt % or less, more preferably 2 wt % or more or 10 wt % or less, and even more preferably 2 wt % or more or 7 wt % or less; and the dispersion thus adjusted is brought into contact with the lithium metal composite oxide (D).

In the case of the lithium metal composite oxide having a layered crystal structure, when the amount of an organic solvent or water to be contacted is large, since lithium in the layered crystal structure dissolves out, it is preferable that the amount of the surface treating agent or the amount of the dispersion in which the surface treating agent is dispersed in the organic solvent or water is limited as described above.

When a small amount of the surface treating agent or the dispersion in which the surface treating agent is dispersed in the organic solvent or water is thus brought into contact with the lithium metal composite oxide (D), the surface treating agent can be brought into contact with the lithium metal composite oxide powder while being mixed with air or oxygen. It can be presumed that since oxygen can thereby be made to remain on the particle surface, it can contribute to the supply of oxygen to be consumed in the oxidative reaction of an organic substance in the later heat treatment.

At this time, it is preferable that not that the above amount of the surface treating agent or the dispersion in which the surface treating agent is dispersed in the organic solvent is at one time brought into contact and mixed with the lithium metal composite oxide powder, but the contacting and mixing treatment is divided in several times and repeated.

In the case of performing the surface treatment as described above, it is preferable to perform drying by heating at, for example, 40 to 120° C., in order to volatilize the organic solvent or water.

(Heat Treatment after Surface Treatment)

After performing the surface treatment as described above, the following heat treatment is preferably performed.

That is, the surface-treated lithium metal composite oxide (D) is preferably subjected to the heat treatment in an atmosphere of an oxygen concentration of 20 to 100% so as to maintain a temperature (meaning a temperature when a thermocouple is brought into contact with a calcination product in a furnace, that is, a product temperature) of 700 to 950° C. for a predetermined time.

Such a heat treatment after the surface treatment can volatilize the organic solvent or water, can decompose side chains of the surface treating agent, and can diffuse aluminum, titanium, or zirconium in the surface treating agent from the surface into the deep layer direction, can suppress the reaction with an electrolyte solution and improve the charge-discharge cycle ability, and can make the low-temperature output characteristics equal to or more than that of surface-treated conventional positive electrode active materials.

Further, when the temperature of the heat treatment after the surface treatment is made to be a temperature of the main calcination or less, it is preferable because the crushing load after the heat treatment can be reduced.

From the viewpoint of more enhancing the effect of such a heat treatment after the surface treatment, the treatment atmosphere in the heat treatment is preferably an oxygen-containing atmosphere. The oxygen-containing atmosphere is preferably an oxygen-containing atmosphere of an oxygen concentration of 20 to 100%, more preferably 30% or more or 100% or less, even more preferably 50% or more or 100% or less, still more preferably 60% or more or 100% or less, and furthermore preferably 80% or more or 100% or less.

Further, the temperature (meaning a temperature when a thermocouple is brought into contact with a calcination product in a calcining furnace) of the heat treatment after the surface treatment is preferably 700 to 950° C., more preferably 750° C. or more or 900° C. or less, even more preferably 850° C. or less, still more preferably 800° C. or less.

Furthermore, the heat treatment time is, depending on the treatment temperature, preferably 0.5 hour to 20 hours, more preferably 1 hour or more or 10 hours or less, and even more preferably 3 hours or more or 10 hours or less.

The kind of the calcining furnace is not especially limited. The calcination can be performed by using, for example, a rotary kiln, a stationary furnace, or other calcination furnaces.

(Crushing)

After the above heat treatment after the surface treatment, the lithium metal composite oxide powder may be crushed.

At this time, it is preferable that the lithium metal composite oxide powder is crushed in such a crushing strength that the change rate of the specific surface area (SSA) before and after the crushing becomes 100 to 250%.

Since it is desirable that the crushing of the heat-treated product after the surface treatment is performed such that fresh surfaces underneath the surface treated layer are not excessively exposed so as to maintain the effect of the surface treatment, the crushing is performed such that the change rate of the specific surface areas (SSA) before and after the crushing becomes preferably 100 to 200%, more preferably 175% or less, even more preferably 150% or less, still more preferably 125% or less.

As one preferable example of such a crushing method, a crushing apparatus (for example, a pin mill) in which crushing is performed by pins fixed on a crushing plate rotating at a high speed in a relative direction, can be used. In the case where the crushing is performed in a step after the surface treatment, the crushing is performed, so as not to shave off the surface portion, preferably at 4,000 to 7,000 rpm, more preferably at 6,500 rpm or less, even more preferably at 6,000 rpm or less.

After the crushing performed as the above, classification may be performed as required. The classification at this time, because of having a technical significance of regulation of the particle size distribution of an aggregated powder and removal of foreign matter, is preferably performed by selecting a sieve having a preferable sieve opening.

<Characteristics and Applications>

The present lithium metal composite oxide is, as required, crushed and classified, and thereafter as required, mixed with other positive electrode materials, and can effectively be utilized as a positive electrode active material of a lithium battery.

A positive electrode mixture can be produced, for example, by mixing the present lithium metal composite oxide, a conductive material composed of carbon black and the like, and a binder composed of a Teflon (registered trade mark) binder and the like. Then, by using such a positive electrode mixture for a positive electrode, using, for example, lithium or a material capable of intercalating and deintercalating lithium, such as carbon, for a negative electrode, and using, for a nonaqueous electrolyte, a solution in which a lithium salt such as lithium hexafluorophosphate (LiPF₆) is dissolved in a mixed solvent of ethylene carbonate-dimethyl carbonate or the like, a lithium secondary battery can be constituted. However, it is not intended to be limited to a battery having such a constitution.

The lithium battery provided with the present lithium metal composite oxide as a positive electrode active material is particularly excellent for a use of a positive electrode active material of a lithium battery that is used as a power supply for driving a motor mounted on, particularly, an electric vehicle (EV) or a hybrid electric vehicle (HEV).

Here, the “hybrid vehicle” represents a vehicle using two power sources including an electric motor and an internal combustion engine in combination, and includes a plug-in hybrid vehicle.

In addition, the “lithium battery” means including all kinds of batteries containing lithium or lithium ions therein, such as a lithium primary battery, a lithium secondary battery, a lithium ion secondary battery, and a lithium polymer battery.

<Explanation of Words and Phrases>

In the present specification, in the case of being expressed as “X to Y” (X and Y are arbitrary numbers), it includes the meaning of being “preferably greater than X” or “preferably smaller than Y” together with the meaning of being “X or more and Y or less” unless otherwise stated.

In addition, in the case of being expressed as “X or more” (X is an arbitrary number) or “Y or less” (Y is an arbitrary number), it also includes the intention to be “preferably greater than X” or “preferably less than Y”.

### EXAMPLES

Next, the present invention will be described further based on Examples and Comparative Examples. However, the present invention is not limited to the following Examples.

### Comparative Example 1

Lithium carbonate (D50: 7 μm), nickel hydroxide (D50: 22 μm), cobalt oxyhydroxide (D50: 14 μm), electrolytic manganese dioxide (D50: 23 μm, spe

cific surface area: 40 m²/g), and aluminum hydroxide (D50: 2.2 μm) were weighed in a molar ratio of Li:Ni:Co:Mn:Al=1.04:0.48:0.20:0.27:0.01, and were introduced in ion-exchanged water, in which a dispersant was dissolved in advance, in this order. These were mixed and stirred to prepare a slurry having a solid content concentration of 50 wt %, and the slurry was pulverized with a wet-type pulverizer at 1,300 rpm for 40 minutes to set the D50 to 0.55 μm, thereby obtaining a pulverized slurry. The obtained pulverized slurry was granulated and dried by using a thermal spraying dryer (spray dryer, OC-16, manufactured by Ohkawara Kakohki Co., Ltd.). At this time, the spraying was performed by using a twin-fluid nozzle, and the granulation and drying was performed at spray pressure of 0.3 MPa, at a slurry supply amount of 3 kg/hr and by adjusting the temperature such that the temperature of the outlet port of the drying tower became 100° C. The average particle diameter (D50) of the granulated powder was 15 μm.

The obtained granulated powder was temporarily calcined by using a stationary electric furnace so as to maintain the temperature of 700° C. for 5 hours in the air, and thereafter cooled down at room temperature. The obtained powder was crushed, and main calcined by again using the stationary electric furnace so as to maintain the temperature of 900° C. for 20 hours in the air.

The powder obtained by the main calcination was crushed and classified with a sieve having a sieve opening of 53 μm, and the powder under the sieve was collected to obtain a lithium manganese nickel-containing composite oxide powder.

### Example 1

Lithium hydroxide (D50: 22 μm), nickel hydroxide (D50: 22 μm), cobalt oxyhydroxide (D50: 14 μm), electrolytic manganese dioxide (D50: 23 μm, specific surface area: 40 m²/g), and aluminum hydroxide (D50: 2.2 μm) were weighed in a molar ratio of Li:Ni:Co:Mn:Al=0.67:0.63:0.30:0.39:0.01; first, nickel hydroxide, aluminum hydroxide and polycarboxylic acid ammonium salt (SN dispersant 5468, manufactured by San Nopco Ltd.) as a dispersant were added to ion-exchanged water such that the slurry solid content became 30 wt %, and pulverized by a wet-type pulverizer at 1,300 rpm for 60 minutes; subsequently, cobalt oxyhydroxide, polycarboxylic acid ammonium salt (SN dispersant 5468, manufactured by San Nopco Ltd.) as a dispersant, and ion-exchanged water were additionally added therein such that the slurry solid content became 50 wt %, and pulverized at 1,300 rpm for 40 minutes; after that, electrolytic manganese dioxide was mixed therein, and pulverized at 1,300 rpm for 40 minutes; and then, lithium hydroxide and ion-exchanged water were additionally added therein such that the slurry solid content became 20 wt %, and pulverized at 500 rpm for 2 minutes to prepare a slurry having D50 of 0.55 μm and a solid content concentration of 20 wt %, thereby obtaining a pulverized slurry.

The obtained pulverized slurry was granulated and dried by using a thermal spraying dryer (spray dryer, OC-16, manufactured by Ohkawara Kakohki Co., Ltd.). At this time, the spraying was performed by using a twin-fluid nozzle, and the granulation and drying was performed at spray pressure of 0.3 MPa, at a slurry supply amount of 3 kg/hr and by adjusting the temperature such that the temperature of the outlet port of the drying tower became 100° C. The average particle diameter (D50) of the granulated powder was 15 μm.

The obtained granulated powder was temporarily calcined by using a stationary electric furnace so as to maintain the temperature of 860° C. for 10 hours in the air, and thereafter cooled down at room temperature. The obtained powder was then crushed, thereby obtaining a lithium metal composite oxide (E) powder.

Subsequently, lithium carbonate (D50: 7 μm, (D90−D10)/D50)=1.6) was added to the lithium metal composite oxide (E) powder thus obtained so as to be a target composition of Li_{1.02}Ni_{0.46}Co_{0.22}Mn_{0.29}Al_{0.01}O₂, and mixed using a ball mill for 1 hour. The obtained mixed powder was main calcined by using a stationary electric furnace at 910° C. for 22 hours in the air.

The powder obtained by the main calcination was crushed and classified with a sieve having a sieve opening of 53 μm, and the powder under the sieve was collected to obtain a lithium metal composite oxide powder (D).

The lithium metal composite oxide (D) thus obtained was crushed by a high-speed rotary pulverizer (pin mill, manufactured by Makino Mfg. Co., Ltd.) (crushing condition: the number of revolutions of 7,000 rpm). Thereafter, the resultant was classified with a sieve having a sieve opening of 53 μm, and a lithium transition metal oxide powder (D) under the sieve was obtained.

The lithium metal composite oxide (D) thus obtained was subjected to a heat treatment in an atmosphere of an oxygen concentration of 92% so as to maintain the product temperature at 850° C. for 5 hours, thereby obtaining a lithium metal composite oxide powder (D).

The lithium metal composite oxide powder (D) obtained by the heat treatment was classified with a sieve having a sieve opening of 53 μm, and a lithium metal composite oxide powder (D) (sample) under the sieve was obtained.

Subsequently, with respect to 100 wt % of the obtained lithium metal composite oxide powder (D), 3.0 wt % of an aluminum coupling agent (Plenact (registered trade mark) AL-M, Ajinomoto Fine-Techno Co., Inc.) as a surface treating agent and 10 wt % of isopropyl alcohol as a solvent were mixed to prepare a dispersion in which the aluminum coupling agent was dispersed in the solvent.

Thereafter, 13 wt % of the dispersion was added to 100 wt % of the lithium metal composite oxide powder (D) obtained by the main calcination, and mixed by using a cutter mill (Millser 720G, manufactured by Iwatani Corp.). Then, the resultant mixture was vacuum dried at 80° C. for 1 hour, and thereafter dried in the air at 100° C. for 1 hour in a dryer.

Thereafter, the resultant was subjected to a heat treatment in an atmosphere of an oxygen concentration of 92% so as to maintain the product temperature at 770° C. for 5 hours, thereby obtaining a surface-treated lithium metal composite oxide powder.

The surface-treated lithium metal composite oxide powder obtained by the heat treatment was crushed by a high-speed rotary pulverizer (pin mill, manufactured by Makino Mfg. Co., Ltd.) (crushing condition: the number of revolutions of 4,000 rpm), and classified with a sieve having a sieve opening of 53 μm, thereby obtaining a surface-treated lithium metal composite oxide powder (sample) under the sieve.

### Example 2

Lithium carbonate, nickel hydroxide, cobalt oxyhydroxide, electrolytic manganese dioxide, and aluminum hydroxide were weighed in a molar ratio of Li:Ni:Co:Mn:Al=0.67:0.67:0.28:0.37:0.01, and granulated in the same manner as in Example 1.

The obtained granulated powder was temporarily calcined by using a stationary electric furnace so as to maintain the temperature of 760° C. for 10 hours in the air, and thereafter cooled down at room temperature. The obtained powder was then crushed, thereby obtaining a lithium metal composite oxide (E) powder.

Subsequently, lithium carbonate (D50: 7 μm, (D90−D10)/D50)=1.6) was added to the lithium metal composite oxide (E) powder thus obtained so as to be a target composition of Li_{1.02}Ni_{0.49}Co_{0.21}Mn_{0.27}Al_{0.01}O₂, and mixed using a ball mill for 1 hour. The obtained mixed powder was main calcined by using a stationary electric furnace at 910° C. for 22 hours in the air.

The powder obtained by the main calcination was crushed and classified with a sieve having a sieve opening of 53 μm, and the powder under the sieve was collected to obtain a lithium metal composite oxide powder (D).

The lithium metal composite oxide (D) thus obtained was crushed by a high-speed rotary pulverizer (pin mill, manufactured by Makino Mfg. Co., Ltd.) (crushing condition: the number of revolutions of 7,000 rpm). Thereafter, the resultant was classified with a sieve having a sieve opening of 53 μm, and a lithium transition metal oxide powder (D) under the sieve was obtained.

The lithium metal composite oxide (D) thus obtained was subjected to a heat treatment in an atmosphere of an oxygen concentration of 92% so as to maintain the product temperature at 770° C. for 5 hours, thereby obtaining a lithium metal composite oxide powder (D).

The lithium metal composite oxide powder (D) obtained by the heat treatment was classified with a sieve having a sieve opening of 53 μm, and a lithium metal composite oxide powder (D) (sample) under the sieve was obtained.

Subsequently, with respect to 100 wt % of the obtained lithium metal composite oxide powder (D), 1.0 wt % of an aluminum coupling agent (Plenact (registered trade mark) AL-M, Ajinomoto Fine-Techno Co., Inc.) as a surface treating agent and 10 wt % of isopropyl alcohol as a solvent were mixed to prepare a dispersion in which the aluminum coupling agent was dispersed in the solvent.

Thereafter, 11 wt % of the dispersion was added to 100 wt % of the lithium metal composite oxide powder (D) obtained by the main calcination, and mixed by using a cutter mill (Millser 720G, manufactured by Iwatani Corp.).

Then, the resultant mixture was vacuum dried at 80° C. for 1 hour, and thereafter dried in the air at 100° C. for 1 hour in a dryer. Thereafter, the resultant was subjected to a heat treatment in an atmosphere of an oxygen concentration of 92% so as to maintain the product temperature at 770° C. for 5 hours, thereby obtaining a surface-treated lithium metal composite oxide powder.

The surface-treated lithium metal composite oxide powder obtained by the heat treatment was classified with a sieve having a sieve opening of 53 μm, thereby obtaining a surface-treated lithium metal composite oxide powder (sample) under the sieve.

### Example 3

Lithium carbonate, nickel hydroxide, cobalt oxyhydroxide, electrolytic manganese dioxide, and aluminum hydroxide were weighed in a molar ratio of Li:Ni:Co:Mn:Al=0.82:0.58:0.32:0.26:0.01, and granulated in the same manner as in Example 1 except that a rotary disk was used, the number of revolutions was set to 24,000 rpm and a slurry supply amount was set to 110 ml/min.

The obtained granulated powder was temporarily calcined by using a stationary electric furnace so as to maintain the temperature of 730° C. for 10 hours in the air, and thereafter cooled down at room temperature. The obtained powder was then crushed, thereby obtaining a lithium metal composite oxide (E) powder.

Subsequently, lithium carbonate (D50: 7 μm, (D90−D10)/D50)=1.6) was added to the lithium metal composite oxide (E) powder thus obtained so as to be a target composition of Li_{1.02}Ni_{0.50}Co_{0.26}Mn_{0.22}Al_{0.01}O₂, and mixed by using a ball mill for 1 hour. The obtained mixed powder was main calcined by using a stationary electric furnace at 920° C. for 22 hours in the air.

The powder obtained by the main calcination was crushed and classified with a sieve having a sieve opening of 53 μm, and the powder under the sieve was collected to obtain a lithium metal composite oxide powder (D).

Subsequently, 0.55 wt % of aluminum hydroxide (Higilite (registered trade mark) H-43M (registered trade mark), Showa Denko K.K.) as a surface treating agent was mixed with 100 wt % of the lithium metal transition oxide powder (D) by using a cutter mill (“Millser 720G”, manufactured by Iwatani Corp.).

Then, the obtained powder was subjected to a heat treatment in an oxygen-containing atmosphere (oxygen concentration of 94 vol %) at 770° C. for 5 hours, thereby obtaining a surface-treated lithium metal composite oxide powder. Thereafter, the resultant was classified with a sieve having a sieve opening of 53 μm, thereby obtaining a lithium metal transition oxide powder (sample) under the sieve.

<Chemical Analysis Measurement>

The lithium metal composite oxide (sample) obtained in each of Examples and Comparative Example was measured according to an ICP emission spectroscopy method, and the composition was calculated.

<Analysis of Surface Portion>

The lithium metal composite oxide powder (sample) obtained in each of Examples and Comparative Example was cut using a focusing ion beam (FIB). The cross-section in the vicinity of the surface of the cut particle was observed by a transmission electron microscope (“JEM-ARM200F,” manufactured by JEOL Ltd.), and analyzed by energy dispersive X-ray spectrometry (EDS).

As a result, it could be confirmed that in the lithium metal composite oxide (sample) obtained in each of Examples 1 to 3, a layer containing a large number of an Al element was present on the surface of each particle.

The thickness of the surface portion was measured by performing a line analysis on the particle surface portion and taking the length between both ends of the peaks of the Al element as a thickness of the surface portion.

<Pulverization for Measurement>

A pulverized sample for measurement was obtained in such a manner that, by using an apparatus, 100AFG/50ATP manufactured by Hosokawa Micron Corp., the lithium metal composite oxide powder (sample) obtained in each of Examples and Comparative Example was supplied in the pulverization chamber at the supply rate of 2 kg/hr, and pulverized under the conditions in which the pulverizing pressure was 0.5 MPa and the number of revolutions of the classifying rotor was 14,900 rpm, and after the pulverization, cyclone collecting was performed.

D50, specific surface area, an amount of LiOH, an amount of Li₂CO₃, a residual alkali amount, and a primary particle diameter of the pulverized sample for measurement thus obtained by the pulverization were measured according to the methods that will be described below.

<Measurement of D50>

For each of the lithium metal composite oxide powders (samples) obtained in each of Examples and Comparative Example before and after the pulverization for measurement, the particle size distribution was measured as follows.

A sample recirculator for laser diffraction particle size distribution analyzer (“Microtrac ASVR”, manufactured by Nikkiso Co., Ltd.) was used; the sample (powder) was introduced in an aqueous solution; the mixture was irradiated with a 40 watts ultrasonic wave for 360 seconds in a flow rate of 40 mL/sec; thereafter, the particle size distribution was measured using a laser diffraction particle size distribution analyzer “HRA (X100)” manufactured by Nikkiso Co., Ltd.; and D50 (μm) was determined from a chart of the volume-based particle size distribution thus obtained.

Here, as the aqueous solution in the measurement, water passed through a 60 μm filter was used, the solvent refractive index was 1.33, the particle transparency condition was reflective, the measurement range was 0.122 to 704.0 μm, the measuring time was 30 seconds, and the average value from two measurements was used as the measurement value.

As to lithium hydroxide, the sample (powder) was dispersed at a pressure of 0.414 MPa using an automatic sample supplier for laser diffraction particle size distribution analyzer (“Microtorac SDC”, manufactured by Nikkiso Co., Ltd.), the particle size distribution (dry method) was thus measured using a laser diffraction particle size distribution analyzer “MT3000II” manufactured by Nikkiso Co., Ltd., and the D50 was determined from a chart of the volume-based particle size distribution thus obtained.

Here, the particle transparency condition in the measurement was reflective, the shape was a non-spherical shape, the measurement range was 0.133 to 704.0 μm, the measuring time was 30 seconds, and the average value from two measurements was defined as the D50.

<Measurement of Specific Surface Area>

For each of the lithium metal composite oxide powders (samples) obtained in each of Examples and Comparative Example before and after the pulverization for measurement, the specific surface area was measured as follows.

First, 2.0 g of the sample (powder) was weighed in a glass cell (standard cell) for an automatic specific surface area analyzer, Macsorb (manufactured by Mountech Co., Ltd.), and was set in an auto sampler. The inside of the glass cell was replaced by a nitrogen gas, and then a heat treatment was performed at 250° C. for 15 minutes in the nitrogen gas atmosphere. Thereafter, it was cooled for 4 minutes while allowing a mixed gas of nitrogen and helium to flow. After cooling, the sample (powder) was measured by a BET one-point method, and the result was shown as “SSA” in Table 1.

Meanwhile, as the adsorption gas in the cooling and measurement, a mixed gas of 30% of nitrogen and 70% of helium was used.

Further, a change rate (A) of the specific surface area was calculated by subtracting the “SSA before the pulverization for measurement” value from the “SSA after the pulverization for measurement” value, and the result was shown as “ΔSSA (A)” in Table 1.

<Measurement of Primary Particle Diameter from Image Analysis>

Each of the lithium metal composite oxide powders (samples) obtained in each of Examples and Comparative Example before and after the pulverization for measurement was cut using a focusing ion beam (FIB). The cross-section of the cut particle was observed using a SEM (scanning electron microscope) at a magnification of 5,000 times, and particles having a size corresponding to D50 were selected. Next, the sample (powder) was photographed by changing a magnification from 2,000 to 10,000 times in accordance with D50. An image which is suitable for obtaining the average primary particle size by using an image analysis software which will be described later can be photographed by setting a photographing magnification to, for example, 10,000 times when the D50 is about 7 μm, 5,000 times when the D50 is about 15 μm, and 2,000 times when the D50 is about 22 μm.

For the photographed image, the average primary particle size of the selected particles was obtained using an image analysis software (MAC-VIEW ver. 4, manufactured by Mountech Co., Ltd.). Here, the average primary particle size means a 50% accumulated particle diameter in a volume distribution (Heywood diameter: equivalent circle diameter).

Further, to calculate the average primary particle size, it is preferable to measure 50 or more primary particles. Therefore, when the number of the measurement particles was insufficient, the measurement was performed by additionally selecting the particles having a size equivalent to D50 and photographing so that the number of the primary particles became 50 pieces or more in total.

The primary particle size thus measured was shown as “primary particle size” in Table 1.

<Measurement of Residual Alkali Amount>

The residual alkali amount was calculated by the following procedure with reference to the Winkler method.

For each of the lithium metal composite oxide powders (samples) obtained in each of Examples and Comparative Example before and after the pulverization for measurement, 10.0 g of each of the lithium metal composite oxide powder (sample) was dispersed in 50 mL of ion-exchanged water, immersed therein for 15 min, and thereafter filtered; and the filtrate was titrated with hydrochloric acid (Winkler method). At this time, by using phenolphthalein and bromophenol blue as indicators, an amount of LiOH, an amount of Li₂CO₃, and a total amount of these were calculated based on the discoloration of the filtrate and the amount of titration at this time, and a mass ratio (wt %) of each amount to the amount of the lithium metal composite oxide was calculated.

Here, the residual alkali amount means a total amount of the amount of LiOH and the amount of Li₂CO₃.

Further, a change rate (B) of the residual alkali amounts before and after the pulverization was calculated by subtracting the residual alkali amount before the pulverization for measurement from the residual alkali amount after the pulverization for measurement, and the result was shown as “Δresidual alkali amount (B)” in Table 1.

<Evaluation of Battery Characteristics>

8.0 g of the lithium metal composite oxide powder (sample) obtained in each of Examples and Comparative Example and 1.0 g of an acetylene black (manufactured by Denki Kagaku Kogyo K.K.) were exactly weighed, and mixed in a mortar for 10 min. Thereafter, 8.3 g of a solution in which 12 wt % of a PVDF (manufactured by Kishida Chemical Co., Ltd.) was dissolved in NMP (N-methylpyrrolidone) was exactly weighed; and the mixture of the lithium metal composite oxide powder and the acetylene black was added thereto, and further mixed. Thereafter, 5 ml of NMP was added and fully mixed to thereby produce a paste. The paste was put on an aluminum foil being a current collector, and made into a coated film with an applicator whose gap was adjusted to 100 to 280 μm, vacuum dried at 140° C. for one day and night, thereafter subjected to roll pressing at a linear pressure of 0.3 t/cm², and punched out into 016 mm to thereby make a positive electrode.

Right before the production of a battery, the positive electrode was vacuum dried at 200° C. for 300 min or more, adhered moisture was removed, and the positive electrode was assembled in the battery. In addition, the average value of the weight of the aluminum foil of ϕ16 mm was determined in advance, and the weight of the positive electrode mixture was determined by subtracting the weight of the aluminum foil from the weight of the positive electrode. Further, the content of a positive electrode active material was determined from the mixing ratio of the lithium metal composite oxide powder (positive electrode active material), the acetylene black, and the PVDF.

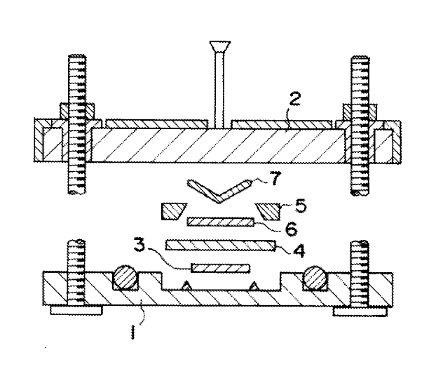

Metallic Li of ϕ19 mm×0.5 mm in thickness was used as a negative electrode active material, and one in which LiPF₆ as a solute was dissolved in 1 mol/L in a mixture as a solvent of EC and DMC in 3:7 in volume was used as an electrolyte solution, thereby producing a cell TOMCEL (registered trade mark) for electrochemical evaluation shown in FIG. 1.

Here, in the cell TOMCEL (registered trade mark) for electrochemical evaluation of FIG. 1, a positive electrode 3 formed from the positive electrode mixture described above was disposed at the center inside a lower body 1 made of stainless steel having resistance to organic electrolyte solution.

At the upper surface of this positive electrode 3, a separator 4 made of a finely porous polypropylene resin, which was impregnated with an electrolyte solution, was disposed, and the separator was fixed by a spacer 5. Further, a negative electrode 6 formed by fixing the metallic Li at the lower surface was disposed on the upper surface of the separator, a spacer 7 which also functioned as a negative electrode terminal was disposed, and the assembly was covered thereon with an upper body 2 and then tightened with screws. Thus, the battery was sealed.

(Initial Activity)

The cell for electrochemical evaluation prepared as described above was subjected to an initial activation using a method described in the following. The cell was charged at 25° C. in a 0.2 C constant current/constant potential mode up to 4.3 V, and thereafter discharged in a 0.2 C constant current mode down to 3.0 V. This process was repeated in two cycles. Here, a current value actually set was calculated from the content of the positive electrode active material in the positive electrode.

(High-Temperature Charge-Discharge Cycle Ability Evaluation: 55° C. High-Temperature Cycle Characteristics)

The cell for electrochemical evaluation after being subjected to the initial activation as described above was subjected to a charge and discharge test using a method described in the following; and the high-temperature cyclability.

The cell was put in an environmental testing chamber whose environmental temperature at which the cell is charged and discharged was set at 55° C., and prepared so as to be able to be charged and discharged; the cell was allowed to stand still for 5 hours such that the cell temperature became the environmental temperature; thereafter, with the charge and discharge range being set at 4.3 V to 3.0 V, the first-cycle charge and discharge was performed in which charge was performed in a 0.2 C constant current/constant potential mode and discharge was performed in a 0.2 C constant current mode; and thereafter, the charge and discharge cycle was performed 50 times at 1 C.

The percentage (%) of a numerical value determined by dividing a discharge capacity of the 50th cycle by a discharge capacity of the second cycle was determined as a “discharge capacity retention rate (%) after 50 cycles”, and shown as a relative value in each of Examples when a “discharge capacity retention rate (%) after 50 cycles” of Comparative Example 1 was set as 100.

TABLE 1

| | | Example 1 | | Example 2 | | Example 3 | | Comparative Example 1 | |
|---|---|---|---|---|---|---|---|---|---|
| | | Before | After | Before | After | Before | After | Before | After |
| | | pulverization | pulverization | pulverization | pulverization | pulverization | pulverization | pulverization | pulverization |
| D50 | μm | 6 | 2 | 7 | 3 | 15 | 2 | 8 | 3 |
| SSA | m²/g | 0.7 | 2.1 | 0.7 | 1.7 | 0.3 | 1.4 | 0.7 | 1.7 |
| LiOH | wt % | 0.02 | 0.07 | 0.06 | 0.11 | 0.06 | 0.07 | 0.08 | 0.13 |
| Li₂CO₃ | wt % | 0.11 | 0.27 | 0.10 | 0.27 | 0.10 | 0.10 | 0.13 | 0.35 |
| Residual alkali amount | wt % | 0.13 | 0.34 | 0.16 | 0.37 | 0.16 | 0.17 | 0.21 | 0.49 |

| Primary particle size | | μm | 0.7 | 0.7 | 1.9 | 0.6 |
|---|---|---|---|---|---|---|
| Residual alkali | | wt %/m²/g | 0.21 | 0.24 | 0.53 | 0.33 |
| amount/SSA | | | | | | |
| Δ SSA | (A) | m²/g | 1.4 | 1.0 | 1.1 | 1.1 |
| Δ residual | (B) | % | 0.21 | 0.21 | 0.01 | 0.28 |
| alkali amount | | | | | | |
| Ratio | B/A | — | 0.15 | 0.20 | 0.01 | 0.26 |

| | | | | | |
|---|---|---|---|---|---|
| Surface thickness | nm | 15 | 17 | 30 | 21 |
| Relative value of | % | 109 | 104 | 101 | 100 |
| discharge capacity | | | | | |
| retention rate after | | | | | |
| 50 cycles | | | | | |

(Consideration)

From the results of the above Examples and the tests carried out by the present inventors so far, with regard to the lithium metal composite oxide having a layered structure, which is represented by Li₁₊ₓNi_{1-x-α-β-γ}Mn_{α}C_{β}M_{γ}O₂ (wherein 0≤x≤0.1, 0.01≤α≤0.35, 0.01≤β≤0.35, 0≤γ≤0.05, and M comprises at least one or more elements selected from the group consisting of Al, Mg, Ti, Fe, Zr, W, Y, and Nb), it was found that, when the amount of residual alkali present in secondary particles was set to 0.05 to 0.4 wt %, the cycle characteristics could be particularly enhanced. At this time, it was also found that, when the amount of residual Li₂CO₃ present in secondary particles was set to 0.03 to 0.3 wt %, the cycle characteristics could be further enhanced.

Furthermore, it was also found that, when the residual alkali amount per specific surface area was less than 0.6 (wt %/(m²/g)), and when the lithium metal composite oxide was pulverized such that the average particle diameter (D50) thereof became 5 to 50%, by suppressing the ratio (B/A) of the change rate (B) of the residual alkali amounts before and after pulverization to the change rate (A) of the specific surface areas before and after pulverization to 0.2 or less, the cycle characteristics could be further enhanced.

Meanwhile, in the above Examples, Al was used as M in the general formula (1): Li₁₊ₓNi_{1-x-α-β-γ}Mn_{α}Co_{β}M_{γ}O₂. However, Al has properties in common with Mg, Ti, Fe, Zr, W, Y, and Nb in the points of the ionic radius and the chemical stability. Thus, it is also considered that, in the case of using at least one or more elements selected from the group consisting of Mg, Ti, Fe, Zr, W, Y, and Nb instead of Al or together with Al as M, an effect similar to those of the above Examples can be obtained.

### DESCRIPTIONS OF SYMBOLS

1 lower body
2 upper body
3 positive electrode
4 separator
5 spacer
6 negative electrode
7 spacer

1. A lithium metal composite oxide having a layered structure,
which is represented by a general formula (1): Li₁₊ₓNi_{1-x-α-β-γ}Mn_{α}Co_{β}M_{γ}O₂ (wherein 0≤x≤0.1, 0.01≤α≤0.35, 0.01≤β≤0.35, 0≤γ≤0.05, and M comprises at least one or more elements selected from the group consisting of Al, Mg, Ti, Fe, Zr, W, Y, and Nb),
wherein an amount of residual alkali present in secondary particles (according to the following measurement method; referred to as “residual alkali amount in secondary particles”) is 0.05 to 0.4 wt %,
wherein in the method of measuring the residual alkali amount in secondary particles,
the lithium metal composite oxide is pulverized such that an average particle diameter (D50) thereof becomes 5 to 50%; 10.0 g of the lithium metal composite oxide after the pulverization is dispersed in 50 mL of ion-exchanged water, immersed therein for 15 min, and thereafter filtered; and the filtrate is titrated with hydrochloric acid (Winkler method), and
at this time, by using phenolphthalein and bromophenol blue as indicators, a total amount of an amount of LiOH and an amount of Li₂CO₃ is calculated based on the discoloration of the filtrate and the amount of titration at this time, and a mass ratio (wt %) of the total amount to the amount of the lithium metal composite oxide is set as a residual alkali amount in secondary particles.

2. The lithium metal composite oxide according to claim 1,
wherein an amount of residual Li₂CO₃ present in secondary particles (according to the following measurement method; referred to as “residual Li₂CO₃ amount in secondary particles”) is 0.03 to 0.3 wt %,
wherein in the method of measuring the residual Li₂CO₃ amount in secondary particles,
the lithium metal composite oxide is pulverized such that the average particle diameter (D50) thereof becomes 5 to 50%; 10.0 g of the lithium metal composite oxide after the pulverization is dispersed in 50 mL of ion-exchanged water, immersed therein for 15 min, and thereafter filtered; and the filtrate is titrated with hydrochloric acid (Winkler method), and
at this time, by using phenolphthalein and bromophenol blue as indicators, the amount of Li₂CO₃ is calculated based on the discoloration of the filtrate and the amount of titration at this time, and a mass ratio (wt %) of the amount of Li₂CO₃ to the lithium metal composite oxide is set as a residual Li₂CO₃ amount in secondary particles.

3. The lithium metal composite oxide according to claim 1,
wherein a residual alkali amount per specific surface area (residual alkali amount before pulverization according to the following measurement method) is less than 0.6 (wt %/(m²/g)), and
when the lithium metal composite oxide is pulverized such that the average particle diameter (D50) thereof becomes 5 to 50%, a ratio (B/A) of a change rate (B) of the residual alkali amounts before and after pulverization (according to the following measurement method) to a change rate (A) of the specific surface areas before and after pulverization is 0.2 or less,
wherein in the method of measuring the residual alkali amount before or after pulverization,
10.0 g of the lithium metal composite oxide before the pulverization or after the pulverization is dispersed in 50 mL of ion-exchanged water, immersed therein for 15 min, and thereafter filtered; and the filtrate is titrated with hydrochloric acid (Winkler method), and
at this time, by using phenolphthalein and bromophenol blue as indicators, the total amount of the amount of LiOH and the amount of Li₂CO₃ is calculated based on the discoloration of the filtrate and the amount of titration at this time, and the mass ratio (wt %) of the total amount to the amount of the lithium metal composite oxide is set as a residual alkali amount before pulverization or after pulverization.

4. The lithium metal composite oxide according to claim 1, comprising a surface portion containing one or a combination of two or more of the group consisting of Al, Ti, and Zr on the surface of the particle composed of the lithium metal composite oxide.

5. A lithium secondary battery, comprising the lithium metal composite oxide according to claim 1 as a positive electrode active material.

6. A lithium secondary battery for a hybrid electric vehicle or an electric vehicle, comprising the lithium metal composite oxide according to claim 1 as a positive electrode active material.

7. The lithium metal composite oxide according to claim 2,
wherein a residual alkali amount per specific surface area (residual alkali amount before pulverization according to the following measurement method) is less than 0.6 (wt %/(m²/g)), and
when the lithium metal composite oxide is pulverized such that the average particle diameter (D50) thereof becomes 5 to 50%, a ratio (B/A) of a change rate (B) of the residual alkali amounts before and after pulverization (according to the following measurement method) to a change rate (A) of the specific surface areas before and after pulverization is 0.2 or less,
wherein in the method of measuring the residual alkali amount before or after pulverization,
10.0 g of the lithium metal composite oxide before the pulverization or after the pulverization is dispersed in 50 mL of ion-exchanged water, immersed therein for 15 min, and thereafter filtered; and the filtrate is titrated with hydrochloric acid (Winkler method), and
at this time, by using phenolphthalein and bromophenol blue as indicators, the total amount of the amount of LiOH and the amount of Li₂CO₃ is calculated based on the discoloration of the filtrate and the amount of titration at this time, and the mass ratio (wt %) of the total amount to the amount of the lithium metal composite oxide is set as a residual alkali amount before pulverization or after pulverization.

8. The lithium metal composite oxide according to claim 2, comprising a surface portion containing one or a combination of two or more of the group consisting of Al, Ti, and Zr on the surface of the particle composed of the lithium metal composite oxide.

9. The lithium metal composite oxide according to claim 3, comprising a surface portion containing one or a combination of two or more of the group consisting of Al, Ti, and Zr on the surface of the particle composed of the lithium metal composite oxide.

10. A lithium secondary battery, comprising the lithium metal composite oxide according to claim 2 as a positive electrode active material.

11. A lithium secondary battery, comprising the lithium metal composite oxide according to claim 3 as a positive electrode active material.

12. A lithium secondary battery, comprising the lithium metal composite oxide according to claim 4 as a positive electrode active material.

13. A lithium secondary battery for a hybrid electric vehicle or an electric vehicle, comprising the lithium metal composite oxide according to claim 2 as a positive electrode active material.

14. A lithium secondary battery for a hybrid electric vehicle or an electric vehicle, comprising the lithium metal composite oxide according to claim 3 as a positive electrode active material.

15. A lithium secondary battery for a hybrid electric vehicle or an electric vehicle, comprising the lithium metal composite oxide according to claim 4 as a positive electrode active material.
